(19) United States
(12) Patent Application Publication
(10) Pub. No.: US 2009/0216610 A1
(43) Pub. Date: Aug. 27, 2009

(54) METHOD FOR OBTAINING CONSUMER PROFILES BASED ON CROSS LINKING INFORMATION

(75) Inventor: Diego Chorny, Madrid (ES)

Correspondence Address: DARBY & DARBY P.C., P.O. BOX 770, Church Street Station, New York, NY, 10008-0770, US

(73) Assignee: BRAND VALUE SL, Madrid (ES)

(21) Appl. No.: 12/036,687

(22) Filed: Feb. 25, 2008

(51) Int. Cl. G06Q 10/00

(52) U.S. Cl. 705/10; 705/14

(57) ABSTRACT

A method for cross linking personal information provided by a plurality of consumers in order to offer such consumers a testing product that will match the profile of such consumer with one or more products or product groups.

### FIELD OF THE INVENTION

The present invention relates to a method of cross linking personal information provided by a plurality of consumers in order to offer such consumers a product that will match the profile of the consumer. Furthermore, the present invention relates to a method to provide a platform of predictive models of consumer behavior wherein the customer is offered a product in exchange for personal information.

### BACKGROUND OF THE INVENTION

For many years, large sums of money have been spent on advertising, marketing and promotion to reach a particular target consumer or audience. General appeal is used where a segment or particular population is desired to be reached. However, as to more specific marketing, such as within segments of target groups, the cost increases in order to personalize or customize the content of the material. Often, groups or segments of a population are selected to market to because that group or segment contains a specific population of individuals who generally share a common trait, characteristic or interest with other individuals of the group. A particularized appeal based on a common trait enables a marketing message directed to that commonality to reach those in the group. However, though persons may be classified into groups, not everyone considered to be part of a group will react in the same manner. Within a group, there are often subgroups or subsets, and within these subsets are individuals. Reaching individuals with known methods is costly, and requires preparation for each individual of the group.

Commercial promotions are tools often used by merchants to boost sales, such as coupons that offer discounts for future purchases, discounts on current purchases in response to excess inventory, shipping upgrades or shipping charge reductions tied to particular circumstances of credit card use, and so forth. Such promotions have understandably become an important aspect of modern electronic commerce.

It is common to advertise products to potential customers by making offers to customers for either a trial of a particular product on a free sample basis, by providing products at a discount or by providing particular advantages. Examples of such advantages include providing additional products, future discounts or free or discounted shipping. Typically, the manner in which customers are targeted is somewhat ad hoc and may simply include handouts or coupons which are obtained from checkouts.

To improve customer targeting, systems have been provided where kiosks are installed at various points in a retail environment, such as a shopping mall, supermarket or hypermarket. These kiosks are fixed in position and require a consumer to interact with the kiosk in order to obtain a coupon or list which details offers available to the consumer. The consumer can redeem the list or coupon at a retail outlet. However, because the kiosks are fixed in position, consumers often bypass them, or if there is a queue, consumers will simply find the interaction process slow and inconvenient. Therefore, this results in relatively low usage rates. Attempts have been made to manage traffic flow (foot traffic) so people pass by the kiosks to increase the likelihood that they will be used. However, such kiosks are still often bypassed, particularly if consumers are in a hurry. Additionally, since coverage is limited to physical interaction at the kiosk, the ability to reach out to consumers is low. Further, such kiosks are expensive, especially since they often occupy the most expensive real estate located in high traffic areas of the retail environment in an attempt to increase consumer availability.

### SUMMARY OF THE INVENTION

The present invention relates to a system and method for obtaining consumer profiles. A user registers to use the system and provides personal information. A consumer profile is then generated by the system which includes the user's personal information. In exchange for providing the personal information, the user is rewarded with points which may be redeemed for coupons on products in a custom made catalog. The products in the custom made catalog are chosen by one or more product providers based on the user's consumer profile. Once the user selects one or more products from the custom made catalog, the system generates a coupon which may be displayed electronically and/or printed out by the user. The coupon may be taken by the user to a retailer and used to purchase the selected product, which may be free or discounted with the coupon.

After the user acquires and uses the selected product, he may log back into the system and fill out a survey regarding the selected product and designed by the product provider. The user data collected by the survey is then sorted into clusters. Each cluster is unique to a selected product or category of products and contains user data entered by users having a particular consumer profile. The product provider may then analyze the user data and create predictive models of consumer behavior for the clusters. Thus, the product provider is able to modify the product or category of products, or adjust their marketing strategy to better target particular clusters.

The user profile may be updated each time user data is entered into a survey, and similarly, the product provider may choose to change a survey for a particular product in order to obtain a more accurate consumer profile and predictive model of behavior. The product provider might also choose to adjust the products offered in particular users custom made catalog order to further segment the consumers in a particular cluster. Additionally, the retailer may use the system to provide users with coupons based on preferences apparent from the users' consumer profiles.

Other features and advantages of the present invention will become more fully apparent and understood with reference to the following description, the accompanying drawings and the appended claims.

### BRIEF DESCRIPTION OF THE DRAWINGS

The foregoing and other features of the present invention will be more readily apparent from the following detailed description and drawings of illustrative embodiments of the invention in which:

FIG. 1 is a flowchart illustrating the operation of the present invention from the customer side;

FIG. 2 is a flowchart illustrating the operation of the present invention from the analyzer side; and

FIG. 3 is a flowchart illustrating the operation of the present invention from the provider side.

### DETAILED DESCRIPTION OF THE INVENTION

In the present invention, software and an associated hardware are utilized by users who are previously registered in a database that saves their consuming history. For the purpose of the invention, this database will be called a fidelization program. The users are offered free or discounted consumer products in exchange for personal information related to the products consumed. This personal information is then processed by the hardware in order to create predictive models of the customer's product consumption behavior.

Due to the nature of the process, the method of the present invention greatly reduces the costs involved in marketing activities oriented to the testing and acquiring of products (e.g., sampling, couponing or market research) by integrating consumer data into hardware that processes the information and generates predictive models. These models may be used to enhance and calculate the return of investments used in marketing actions.

In the method of the present invention, a database prepared from a fidelization program is submitted to a registry process in the system. This system permits a registered user to obtain one or more consumer products of interest (either free or at a discount) in exchange for personal data related to the chosen product or products. A consumer profile is created either during initial registration or after a first product has been chosen by having the user fill in a survey. The survey incorporates personal data entered by the user which is based on consumer preferences and/or products chosen in the past by the user. The consumer profile is updated each time a survey is filled out by the user.

Once the user is registered into the system, the user is awarded initial credits (e.g., bonus points or virtual money) that can be used to pick a product selected from a specific catalog in the user's account. According to the user's consumer profile, the system will generate a custom made catalog from which the user can select a desired product. After the user has selected one or several products (depending on the amount of credit that the user has in his account), the system will generate an electronic coupon for the chosen product or products. The user will then print out his coupons and proceed to the marketplace where the user will pick the selected product from the shelf. Afterward, the user will hand his coupons to the cashier and, if it is a discount coupon, the user will pay the difference. It is important to note, that the method of the invention also contemplates the presentation of the coupon by any electronic means. For example, the coupon could be sent to a cellular telephone. Thus, the user can merely show his cellular telephone to the teller in order to obtain the selected product for free or at a discount.

Once the user obtains and uses the selected products, the user may log into his or her account and fill out a survey generated for each of the products that the user has selected. By filling out this survey, the user is again awarded with credit which can be used to select an additional product or products from the custom made catalog. Each survey filled out by the user may be utilized to update the user's consumer profile. Thus, a more accurate predictive model of consumer behavior may be generated by constantly updating personal data relating to products chosen by the user in the past. Additionally, each survey or updated consumer profile may be used to modify the products included in the custom made catalog in order to provide vital information about the consumers. For example, the manufacturers of offered products could obtain information which would allow them to micro segment consumer groups or populations by modifying the products offered in the custom made catalog according to past surveys.

Once a user has given enough personal information through the system, the user data associated with the user's shopping behavior is incorporated into the fidelization program to be processed and divided into clusters. Preferably, each cluster is specific to a particular product or category of products and includes responses from users who match a particular profile.

The system of the present invention may incorporate user responses which include qualitative information along with the consumption information from the databases. The system will store the responses of users who have been organized into a specific cluster, thereby allowing the system to cross link the stored data and generate predictive models of behavior. Preferably, the clusters are specific to a product or category of products as it is possible that a user who showed a particular consumer behavior for one product might have a completely different consumer behavior regarding another product.

This form of product testing results in a reduction of logistics costs and an increase in the redemption of coupons and user feedback, thereby allowing the system to further segment based on costs and behaviors associated therewith in order to offer specific coupons to a target group of customers. Furthermore, the system allows each manufacturer or product distributor to analyze constantly updated data relating to their products in order to determine whether a particular product meets the expectations of the target customers or not.

The system also eliminates or reduces the risk of the occurrence of coupon fraud since the system controls the generation of coupons and once a coupon is redeemed by a user the system will automatically void the coupon. Further, since the system generates the coupon for each user and stores information relating each user's likes and dislikes about a product, the coupon may include information which would allow the retailer to interact more effectively with its customers.

Further, the system defines behavior characteristics based on the qualitative information used to make the clusters. These behavior characteristics can include how the user reacts to brands and prices or to a special or particular type of offer. Thus, the behavior characteristics can be used to sort the customer into several categories such as: brand choosers, rational buyers, economist, cherry pickers, etc. Moreover, several sub categories can be generated with the information provided from the behavior characteristics such as lifestyle, affinity, family group, tastes, likes, etc.

Each time the customer has acquired the selected product or products from his custom made catalog using the available credit in his account, he or she has the option to start the whole cycle or selection again. In order to earn more points or credits, the customer must log into his account and fill out each survey related to the product that he has recently acquired. Once the survey has been fully completed for that specific product, the used points or credits associated with the product will be reassigned to his or her account in order to select another product from his catalog. Optionally, the user may select one product and have leftover credits which may be used later, even before a survey has been filled out for the first product. In this way, a user may have a queue of selected products for which surveys have yet to be filled out, as well as a balance of remaining credits which may be used for additional products and replenished as surveys are filled out. Furthermore, more or less credits may be provided to the user based upon each consecutive survey. In other words, the number of credits awarded for the completion of a particular survey may be more or less than the number of credits which were required to select the product associated with the completed survey in order to provide incentives so that users continue using the system.

The survey has two primary purposes. The first is to collect information desired by a manufacturer or product provider regarding a specific product. This part of the survey will include questions regarding specific points of interest to the manufacturer or product provider in order to allow them to enhance the quality of the product or modify it to increase its marketability. Additionally, through the use of multiple surveys or modified product offerings, the manufacturer or product provider will be given enough information to allow them to further segment their target consumers. The second purpose is to dynamically place the user, having an updated consumer profile, into corresponding clusters as more data relating to the user is stored in the database. Thus, as a user tests a number of different products, preferably at least 10 to 15, from the user's customized catalog, the system will store enough information to generate a profile showing what type of consumer the user is, and the reasons he or she consumes differently in various product categories. Once this information is acquired, it is used to place the user into corresponding clusters that will be used in a predictive model to illustrate how consumers fitting various profiles will react to a particular product or product category.

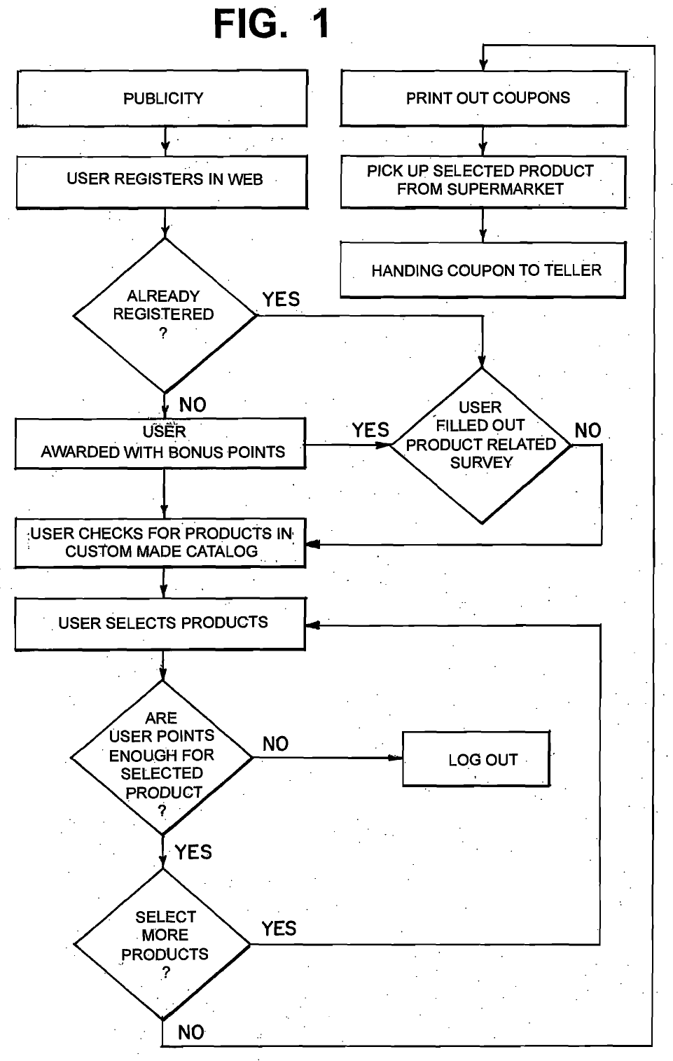

FIG. 1 illustrates the operation of the present invention from the user or customer side. A user will find out about the service via publicity, such as radio, marketing billboards, the internet or other commercial mediums. He or she will go to a specified web site and will sign in. If he or she is not a registered user, the system will show him a form that he or she must fill in order to become a registered user. The form can include several questions related to personal data, such as birth date, annual income, marital status, address and other questions related to the user's tastes in products. Once the user is registered, the system rewards the user with credits or bonus points. In the event that the user is already registered, the system will take him directly into his account where the user may browse the products offered by the system in the user's custom made catalog or fill out a survey relating to a previously selected product. When the user selects one or more products, the system checks that there are enough credits or points in the user's account and, in any case, allows the user to keep on browsing the products. Once the user has finished searching for products or has selected those products that can be acquired by their credit or point balance, the user can go to a page and print out the corresponding coupon or coupons. After printing the coupon, the user may then go to the local store or retailer (e.g., supermarket, mini-market, grocery store or other product provider utilizing the system) to pick up the selected product from the shelf at the store. The user takes the product to the cashier or teller at the checkout counter and presents the coupon, thereby redeeming the coupon for the selected product (for free or at a discount).

After the user has acquired and used the selected product, the user may log into his account and fill out a custom made survey relating to the selected product. Once the survey has been completed, the user is awarded with more points. For example, if the user has selected, acquired and used a product with a value of 100 points, the user may complete a survey regarding the product in order to get the 100 points credited back. The amount of points credited back may vary based on a number of factors, such as the extent to which the survey was completed, the user's feedback, the number of surveys the user has completed, etc.

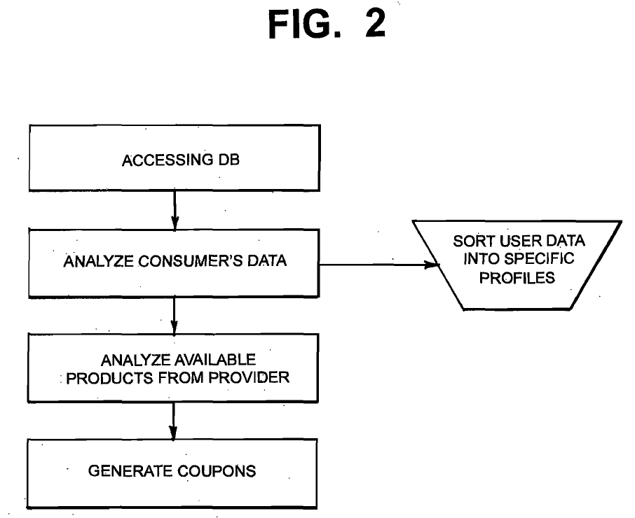

FIG. 2 illustrates the steps taken by the system from the analyzer side. The store or retailer may access the system's database (DB) in order to analyze the consumer's data (i.e., the user data). The store may sort the stored user data (e.g., the user's answers to questions designed by the product provider such as reactions to price and brand) into specific clusters based on the product or product category. The clusters can be designed to encompass particular profiles, including factors such as range of age, social level, economical level, geographical zone, previously selected products, quantity consumed, etc. As such, the store is able to cross link consumer profiles with associated consumption data for a particular product or product category in order to determine what products it will offer to user's having a particular profile or being located in a particular cluster. Accordingly, the store may use the system to generate coupons based upon the user's profile and consumption data regarding a particular product.

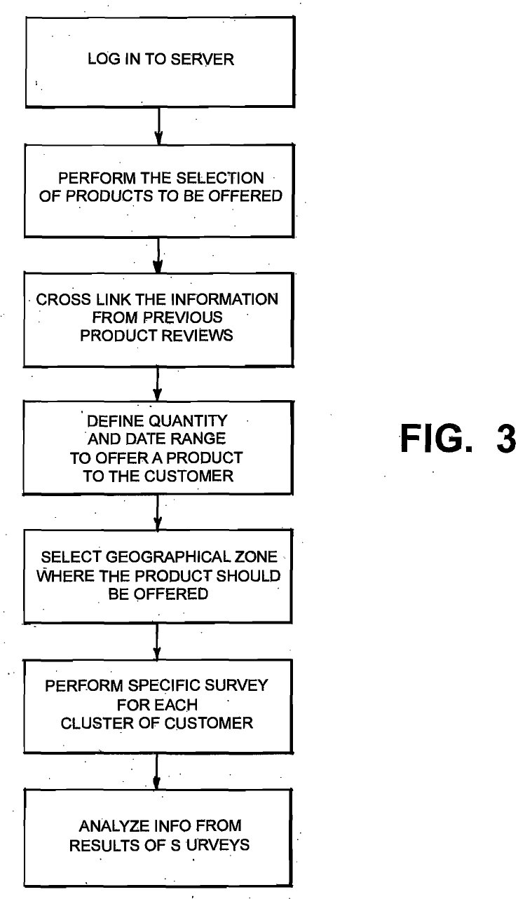

FIG. 3 shows the steps performed by the system of the present invention from the product provider point of view. The product provider logs into the system using a username and password in order to gain access to the product provider's personal account in the system. Once on the system, the product provider may select one or more of his products to appear in the custom made catalog for the user. The product provider will also have access to the database of the system in which the customer's profiles or clusters will be present. Cross linking user data from previous reviews of products will allow the provider to determine which of his products should be placed in the user's custom made catalog and will allow the product provider to control several factors like the quantity, the date range in which the product will be available in the catalog and the geographic zone in which the product will be offered. The product provider will create a custom survey for each profile or cluster of users regarding the specific products. When the user fills out the survey, the user data will be analyzed by the product provider in order to determine the user's likes and dislikes about the product. This will allow the product provider to define several marketing strategies as well as development plans for future products.

While the invention has been particularly shown and described with reference to preferred embodiments thereof, it will be understood by those skilled in the art that various changes in form and details may be made therein without departing from the spirit and scope of the invention.

What is claimed is:

1. A method for obtaining consumer profiles comprising:
collecting personal information from a user;
creating a profile for the user which incorporates the personal information;
offering the user one or more products based on the profile;
generating a coupon for a selected product, the selected product having been chosen by the user from the one or more products offered;
providing a survey for the selected product;
storing user data entered by the user in connection with the survey;
associating the user data with a cluster, wherein the cluster is unique to the selected product; and
updating the profile to incorporate the user data.

2. The method of claim 1, wherein the cluster includes multiple user data from a plurality of users having a particular profile.

3. The method of claim 1, further comprising the step of:
offering the user one or more products based on the updated profile.

4. The method of claim 2, further comprising the steps of:
linking the user data from the plurality of users to the selected product; and
generating a predictive model of behavior for the cluster.

5. A system for obtaining consumer profiles comprising:
a processor; and
a memory coupled to the processor;
wherein the memory is configured to store a program executable by the processor and operable to perform the following steps:
store personal information entered by a user;
generate a profile for the user incorporating the personal information;
generate a list of one or more products based upon the profile; and
generate a coupon for a selected product if one of the one more products is selected by the user;
store a survey and user data input into the survey by the user regarding the selected product; and
associate a cluster to the selected product, the cluster comprising multiple user data entered into the survey by a plurality of users.

6. The system of claim 5, wherein the processor is configured to update the profile according to the user data entered into the survey by the user.

7. The system of claim 6, wherein the memory is configured to store the updated profile.

8. The system of claim 5, wherein the processor is configured to generate a predictive model of behavior for the cluster.

9. A method for obtaining consumer profiles comprising:
preparing a survey for a particular product to be filled out by a plurality of consumers having a particular consumer profile;
accessing a database containing user data associated with a plurality of consumers, the user data having been associated with one or more clusters according to the particular consumer profile and the particular product; and
linking the cluster and the particular product in order to analyze the user data and generate a predictive model of behavior for the cluster;

10. The method of claim 9, further comprising the step of:
adjusting the survey according to the predictive model of behavior for the cluster.

11. The method of claim 9, further comprising:
generating a coupon for the particular product according to the predictive model of behavior for the cluster.
